(19) United States
(12) Patent Application Publication
(10) Pub. No.: US 2025/0056411 A1
(43) Pub. Date: Feb. 13, 2025

(54) METHOD AND APPARATUS FOR NETWORK POWER SAVING

(71) Applicant: MEDIATEK INC., Hsinchu City (TW)

(72) Inventors: Chien-Chun CHENG, Hsinchu City (TW); Wei-De WU, Hsinchu City (TW); Yi-Ju LIAO, Hsinchu City (TW); Cheng-Hsun LI, Hsinchu City (TW)

(21) Appl. No.: 18/719,419

(22) PCT Filed: Apr. 28, 2023
(86) PCT No.: PCT/CN2023/091767

§ 371 Date: Jun. 13, 2024

Related U.S. Application Data
(60) Provisional application No. 63/337,641, filed on May 3, 2022.

(51) Int. Cl. H04W 52/02; H04B 7/06; H04W 76/28

(52) U.S. Cl. CPC H04W 52/0235; H04B 7/0626; H04W 76/28

(57) ABSTRACT

Various solutions for network power saving with respect to user equipment and network apparatus in mobile communications are described. An apparatus may receive a power saving indication. The apparatus may obtain power saving information according to the power saving indication. The power saving indication may comprise at least one of a discontinuous reception (DRX) switch indicator for switching between a user equipment (UE)-specific-DRX (U-DRX) and a group-specific-DRX (G-DRX), an energy saving mode (EMS) indication, a list of synchronization signal block (SSB) or channel state information-reference signal (CSI-RS) resources, and a set of transmission configuration indication (TCI)I states or RS resource indexes.

### CROSS REFERENCE TO RELATED PATENT APPLICATION(S)

The present disclosure is part of a non-provisional application claiming the priority benefit of U.S. Patent Application No. 63/337,641, filed 3 May 2022, the content of which herein being incorporated by reference in its entirety.

### TECHNICAL FIELD

The present disclosure is generally related to mobile communications and, more particularly, to network power saving with respect to user equipment (UE) and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Therefore, it is important to achieve 5G network power savings. There are many conflicts among performance metrics. Quality of service (QoS) and power savings may need a tradeoff. Some local optimal solutions may not achieve the global/overall optimum. For example, the wake-up signal (WUS) saving user equipment (UE) power by 20% may degrade 30% of base station (BS) power savings.

In conventional technologies, WUS associates with discontinuous reception (DRX) occasions, and paging early indication (PEI) associates with paging occasions. These associations may maximize UE latency and power consumption. However, WUS and PEI should better associate with synchronization signal block (SSB) and system information block 1 (SIB1) to get more BS sleep time from 5G network power savings.

Accordingly, how to achieve network power saving becomes an important issue for the newly developed wireless communication network. Therefore, there is a need to provide proper schemes for network power saving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to network power saving with respect to user equipment and network apparatus in mobile communications.

In one aspect, a method may involve an apparatus receiving a power saving indication from a network node. The method may also involve the apparatus obtaining power saving information according to the power saving indication. The power saving indication may comprise at least one of a discontinuous reception (DRX) switch indicator for switching between a user equipment (UE)-specific-DRX (U-DRX) and a group-specific-DRX (G-DRX), an energy saving mode (EMS) indication, a list of synchronization signal block (SSB) or channel state information-reference signal (CSI-RS) resources, and a set of transmission configuration indication (TCI) states or RS resource indexes.

In one aspect, an apparatus may involve a transceiver which, during operation, wirelessly communicates with at least one network node. The apparatus may also involve a processor communicatively coupled to the transceiver such that, during operation, the processor performs following operations: receiving, via the transceiver, a power saving indication from the network node; and obtaining power saving information according to the power saving indication. The power saving indication may comprise at least one of a DRX switch indicator for switching between a UE-specific-DRX (U-DRX) and a group-specific-DRX (G-DRX), an EMS indication, a list of SSB or CSI-RS resources, and a set of TCI states or RS resource indexes.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of DRX switching under schemes in accordance with implementations of the present disclosure.

FIG. 2 is a diagram depicting another example scenario of DRX switching under schemes in accordance with implementations of the present disclosure.

FIG. 3 is a diagram depicting an example scenario of paging occasion (PO) for DRX under schemes in accordance with implementations of the present disclosure.

FIG. 4 is a diagram depicting an example scenario of new ps-offset for DRX under schemes in accordance with implementations of the present disclosure.

FIG. 5 is a diagram depicting an example scenario of different versions of ps-Offsets for DRX under schemes in accordance with implementations of the present disclosure.

FIG. 6 is a diagram depicting an example scenario of WUS monitor occasion (MO) for DRX under schemes in accordance with implementations of the present disclosure.

FIG. 7 is a diagram depicting an example scenario of WUS MO after a SSB under schemes in accordance with implementations of the present disclosure.

FIG. 8 is a diagram depicting an example scenario of SMTC window for WUS under schemes in accordance with implementations of the present disclosure.

FIG. 9 is a diagram depicting an example scenario of SI window for WUS under schemes in accordance with implementations of the present disclosure.

FIG. 10 is a diagram depicting an example scenario of energy saving mode (ESM) switch under schemes in accordance with implementations of the present disclosure.

FIG. 11 is a diagram depicting an example scenario of beam configuration for network power saving under schemes in accordance with implementations of the present disclosure.

FIG. 12 is a diagram depicting another example scenario of beam configuration for network power saving under schemes in accordance with implementations of the present disclosure.

FIG. 13 is a diagram depicting an example scenario of CSI pattern training procedure for network power saving under schemes in accordance with implementations of the present disclosure.

FIG. 14 is a block diagram of an example communication system in accordance with an implementation of the present disclosure.

FIG. 15 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to using on-demand reference signal for network energy saving with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

The present disclosure proposes several schemes pertaining to network power saving (or network energy saving) with respect to UE and network apparatus in mobile communications.

In convention technologies, when the values of drx-SlotOffset, i.e., the delay before starting the drx-onDurationTimer, are not aligned among UEs, the network node may send multiple wake-up signals (WUSs) to meet each UE's on-duration. Ideally, the WUS should indicate more than one UE. However, in the worst case, the network node may broadcast the WUS for only one UE that should monitor it. For example, if ps-Offset is the same, e.g., 6 millisecond (ms), and discontinuous reception (DRX) start offset is different, e.g., 10 ms, 14 ms, and 18 ms for three UEs, the network node may broadcast downlink control information (DCI) format 2_6 three times to wake UEs up. It may lead to low-efficiency signaling and power waste. In convention technologies, in order to solve the issue, the network node may align the WUS in a cell by using different ps-Offsets and the same DRX start offset. However, using ps-Offset may indicate the WUS into a UE's DRX active time, and thus, the WUS may fail to wake up the UE. DRX alignment among UEs may not fit UE's preferred DRX start offset. The DRX start offset may not align with the start offset from different UE's traffic patterns, resulting in additional latency. In addition, if the UE is operated in dual connectivity (DC), two medium access control (MAC) entities may need UE-specific DRX to start offsets to align two DRX patterns from NR and LTE. For example, if ps-Offsets are different, e.g., ps-Offset=6 ms, 10 ms, and 14 ms, the network node may align the WUS and broadcast it once for all UEs. However, since the UE may not monitor PDCCH for detecting DCI format 2_6 during active time according to 3GPP Technical Specification (TS) 38.213, the UE may not wake up via the WUS. For example, the network node may align the WUS and DRX among UEs, e.g., set DRX start offset=10 ms and ps-Offset=6 ms to all UEs. However, when UEs have different values on traffic start offset, e.g., a first UE has 2 ms, and a second UE has 4 ms of traffic start offset, the network node may buffer the downlink (DL) data of the second UE for more than 20 ms as a DRX long cycle to align this DRX setting. This may degrade UE's latency performance and may fail to meet UE's QoS requirement. For example, when a UE is configured with a Secondary Cell Group (SCG), the UE is configured with two Medium Access Control (MAC) entities, one MAC entity for a Master Cell Group (MCG) and the other MAC entity for the SCG. Since the MAC entities should run independently, the DRX on-Duration on both MAC entities may not be aligned, and the UE may wake up individually for each MAC entity. In convention technologies, the WUS is offset before the on-duration starts. When there are different DRX settings in a cell, the on-duration cannot be aligned. Thus, the WUS cannot be aligned as well. Therefore, the present disclosure proposes some solutions to resolve the issues.

In some implementations of the present disclosure, the UE may receive a WUS configuration in system information (SI) or radio resource control (RRC) from the network, and the UE may monitor the WUS using the WUS parameters in the WUS configuration provided by the network node. In addition, the UE may receive a DRX configuration. If the UE detects the WUS, the UE may monitor the physical downlink control channel (PDCCH) in the following K DRX on-duration or until a PDCCH is received according to the DRX configuration, where K is the number of consecutive DRX on-duration mapped to one WUS provided by the network node via SI or RRC with values from 1 to K_max. The UE may start monitoring the WUS in a search space set WUS_{SearehSpace} in the subframe WUS_{subframe} in the radio frame WUS_{SFN}, where WUS_{SearehSpace}, WUS_{subframe}, and WUS_{SFN} may be configured by the network node or determined by the UE. For example, the UE may determine the system frame number (SFN) and the subframe for the WUS by the following equation, [(SFN×10)+subframe number]modulo (WUS-Cycle)=WUS-StartOffset, where the network node may configure WUS-Cycle and WUS-StartOffset via RRC or SI.

If the UE starts monitor the WUS, the UE may stay monitoring the WUS for the maximum duration configured in SI or RRC. The length may include invalid subframes, e.g., due to SSB collision, beam direction, or time division duplex (TDD) configurations. If the UE receives the WUS but has no processing time, the UE may not wake up in the following DRX on-duration. The UE may report the processing time via RRC. The UE may receive an offset between the WUS and a configured frame, e.g., a paging frame, an SSB frame configured by the SMTC configuration, or a system information frame configured by the SI window. Values of the offset may be in ms, frame, subframe, or slot.

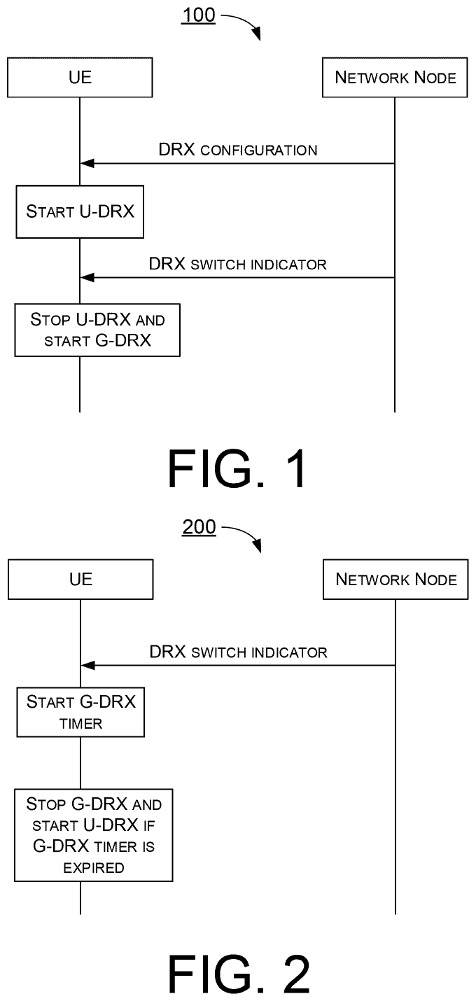

FIG. 1 illustrates an example scenario 100 of DRX switching under schemes in accordance with implementations of the present disclosure. Scenario 100 involves a network node (e.g., a macro base station and multiple micro base stations) and a UE, which may be a part of a wireless communication network (e.g., an LTE network, a 5G/NR network, an IoT network or a 6G network). The UE may receive group-specific DRX (G-DRX) parameters and UE-specific DRX (U-DRX) parameters in the DRX configuration from the network via RRC or SI. If the G-DRX parameters are configured, the UE may switch from U-DRX to G-DRX or switch from G-DRX to U-DRX when the UE receive a DRX switch indicator, e.g., via a UE-group common signaling of a DCI format.

The UE may receive an offset between a G-DRX start frame and a configured frame, e.g., a paging frame, an SSB frame configured by the SSB-based measurement timing configuration (SMTC) configuration, or a system information frame configured by the SI window. Values of the offset may be in ms, frame, subframe, or slot. The UE may determine a G-DRX occasion by the associated frame and the offset.

The G-DRX parameters may be configured per bandwidth part (BWP), per cell, per cell group, or per UE. The G-DRX parameters may be the same for a UE group, including UE group ID, UE ID, and legacy DRX parameters, e.g., DRX cycles, durations, and offsets. The UE may stop U-DRX when G-DRX starts.

The DRX switch indicator may include UE group ID, UE ID, and DRX switch indication. The UE may receive the DRX switch indicator via a DCI format with cyclic redundancy check (CRC) scrambled by power saving-radio network temporary identifier (PS-RNTI) or a new RNTI. The DCI format may include N blocks, and the UE may determine a block by the parameters provided by the RRC, the UE group ID, or UE ID by the DCI format. The block information comprises the DRX switch indication of one or more bits, indicating a switch between G-DRX and U-DRX or switching to a specific DRX setting associated with UE group ID.

FIG. 2 illustrates another example scenario 200 of DRX switching under schemes in accordance with implementations of the present disclosure. Scenario 200 involves a network node (e.g., a macro base station and multiple micro base stations) and a UE, which may be a part of a wireless communication network (e.g., an LTE network, a 5G/NR network, an IoT network or a 6G network). The UE may switch between G-DRX and U-DRX based on a G-DRX timer. The G-DRX timer may be an alternative for DRX switching. The G-DRX-timer may start or restart when the UE receives the DRX switch indicator. For example, when UE changes to G-DRX settings, the UE may start a timer G-DRX-timer. Then, when the G-DRX-timer is expired, the UE may switch back to U-DRX settings.

When the UE receives U-DRX settings and G-DRX settings (or U-DRX parameters and G-DRX parameters), the UE may apply U-DRX before receiving any DRX switch indicator. When the UE receives G-DRX settings only, the may UE wait for the first DRX switch indicator to use and start G-DRX operation.

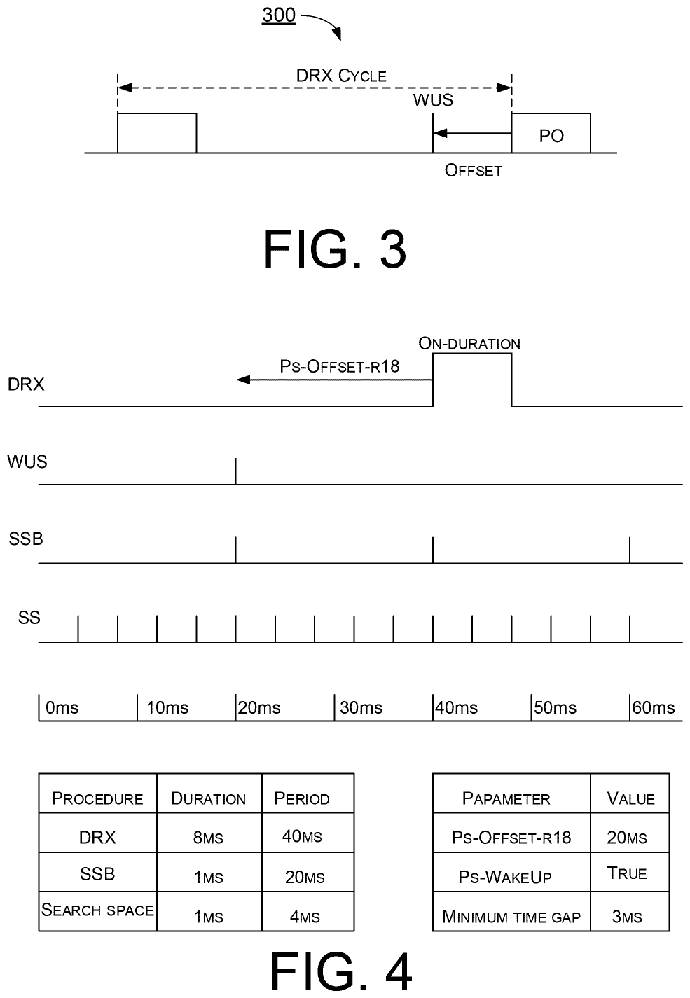

FIG. 3 illustrates an example scenario 300 of paging occasion (PO) for DRX under schemes in accordance with implementations of the present disclosure. Scenario 300 involves a network node (e.g., a macro base station and multiple micro base stations) and a UE, which may be a part of a wireless communication network (e.g., an LTE network, a 5G/NR network, an IoT network or a 6G network). The UE may monitor a WUS with an offset before or within a paging occasion (PO). The WUS may be used to determine whether the UE needs to monitor the PDCCH in the following DRX on-duration.

If the WUS cannot align with the SSB transmission, the network node may wake up between SSBs and take additional energy consumption due to losing an opportunity to enter sleep modes. The network node may optimize its energy savings by proper configurations among ps-Offset, DRX, SSB, and search space. However, it is challenging to align the WUS with the SSB because the max offset value of the WUS is 15 ms, and the typical SSB period is 20 ms. Therefore, the present disclosure proposes some solutions to resolve the issues.

FIG. 4 illustrates an example scenario 400 of new ps-offset for DRX under schemes in accordance with implementations of the present disclosure. Scenario 400 involves a network node (e.g., a macro base station and multiple micro base stations) and a UE, which may be a part of a wireless communication network (e.g., an LTE network, a 5G/NR network, an IoT network or a 6G network). The UE may receive a new offset ps-Offset-r18 from the network node. The value range of the new offset ps-Offset-r18 may be from 0.125 ms to 20 ms with an RRC information element (IEL) ps-Offset-r18 of INTEGER (1-160). The new IE of new offset ps-Offset-r18 may indicate the start of the search-time of DCI format 2_6 with CRC scrambled by PS-RNTI relative to the beginning of the drx-onDurationTimer of Long DRX. The value of the new offset ps-OFFset-r18 may be set in multiples of 0.125 ms (milliseconds).

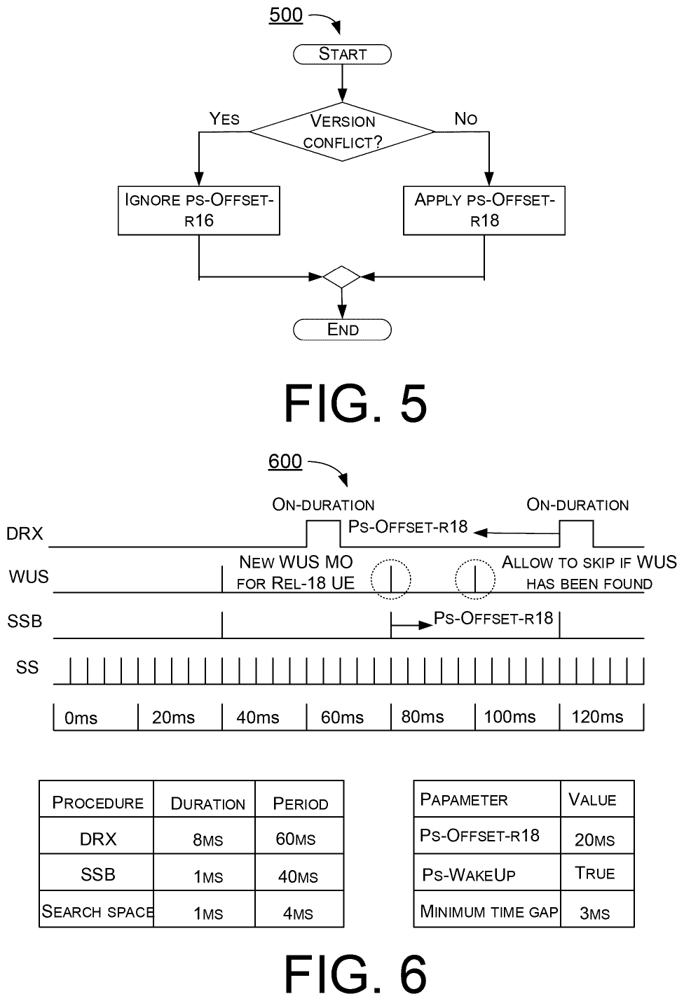

FIG. 5 illustrates an example scenario 500 of different versions of ps-Offsets for DRX under schemes in accordance with implementations of the present disclosure. Scenario 500 involves a network node (e.g., a macro base station and multiple micro base stations) and a UE, which may be a part of a wireless communication network (e.g., an LTE network, a 5G/NR network, an IoT network or a 6G network). As shown in FIG. 5, if UE receives both new offset ps-Offset-r18 and old offset ps-Offset-r16 (i.e., the version conflict occurs), the UE may ignore old offset ps-Offset-r16 and use new offset ps-Offset-r18.

However, if the network node uses an SSB period greater than 20 ms, the ps-Offset-r18 may not align WUS and SSB for every DRX cycle. For example, when the SSB period is 40 ms and the DRX period is 60 ms, the network node may wake up between SSBs given the offset of 20 ms. It is challenging to align the WUS and the SSB for all configurations among DRX, SSB, and search space. Therefore, the present disclosure proposes some solutions to resolve the issues.

FIG. 6 illustrates an example scenario 600 of WUS monitor occasion (MO) for DRX under schemes in accordance with implementations of the present disclosure. Scenario 600 involves a network node (e.g., a macro base station and multiple micro base stations) and a UE, which may be a part of a wireless communication network (e.g., an LTE network, a 5G/NR network, an IoT network or a 6G network). The UE may receive a new WUS monitor occasion (MO) configuration associated with the start of DRX ON and the SSB from the network node. The new WUS MO may start at the SSB reception or after the SSB reception until the end of the range of monitoring, configured by a new RRC IE ps-Range-r18. Before the start of DRX on-duration, the UE may start monitoring the PDCCH with CRC scrambled by PS-RNTI at a slot of the SSB reception or after a slot of the SSB reception until the end of the configured range of monitoring via RRC IE ps-Range-r18. The monitoring may be performed according to the number of search space sets. For each search space set, the UE may monitor DCI format 2_6 only in the 1st entire duration at the slot of the SSB reception or after the slot of the SSB reception, but before the DRX on-duration. If the UE receives WUS after the SSB indicated by ps-Range-r18 before starting ps-Offset with DRX on-duration, the UE may skip the WUS MO indicated by ps-Offset-r16 or ps-Offset-r18; otherwise, the UE may skip the WUS MO indicated by ps-Range-r18. If the SSB cycle is smaller than the DRX cycle, the UE may only monitor the WUS MO associated with the nearest SSB but before the start of DRX on-duration. If the WUS MO is too close to ensure the processing time, the UE may ignore the WUS MO.

In addition, in an example, the UE may monitor multiple WUS MOs associated with a single SSB burst set if the SSB cycle is greater than the DRX cycle. The UE may determine the first WUS MO by ps-Range-r18. The UE may determine the following WUS MO by ps-Offset-r18. For the first WUS MO, if UE receives a WUS, the UE may monitor the following WUS MO before each start of DRX on-duration until the next SSB burst set. The UE may skip the following WUS MO before the next SSB burst set if the UE receives no WUS in the first WUS MO. The period of WUS MO may have one or multiple SSB periods.

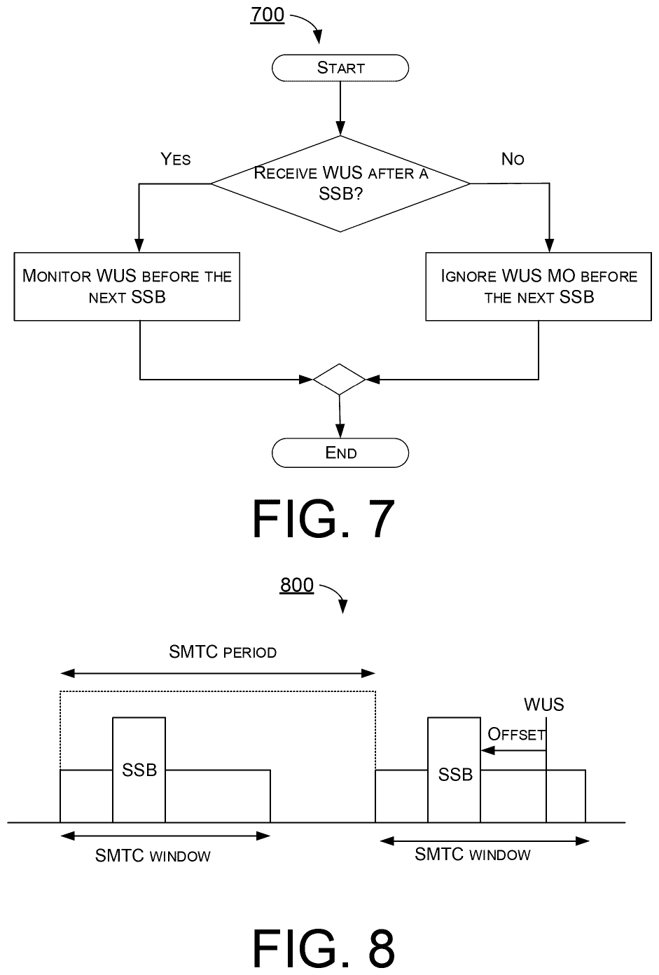

FIG. 7 illustrates an example scenario 700 of WUS MO after a SSB under schemes under schemes in accordance with implementations of the present disclosure. Scenario 700 involves a network node (e.g., a macro base station and multiple micro base stations) and a UE, which may be a part of a wireless communication network (e.g., an LTE network, a 5G/NR network, an IoT network or a 6G network). The UE may monitor WUS after an SSB reception. If the UE receives WUS after an SSB reception, the UE may monitor the WUS before the next SSB reception. If the UE does not receive WUS after an SSB reception, the UE may ignore WUS MO before the next SSB reception.

FIG. 8 illustrates an example scenario 800 of SMTC window for WUS under schemes in accordance with implementations of the present disclosure. Scenario 800 involves a network node (e.g., a macro base station and multiple micro base stations) and a UE, which may be a part of a wireless communication network (e.g., an LTE network, a 5G/NR network, an IoT network or a 6G network). The UE may monitor WUS offset after an SSB reception within a range. The UE may only monitor WUS within an SMTC window. The UE may monitor WUS offset after the start of the SMTC window or the end of the SMTC window. The network node may configure the offset via RRC messages or SIB.

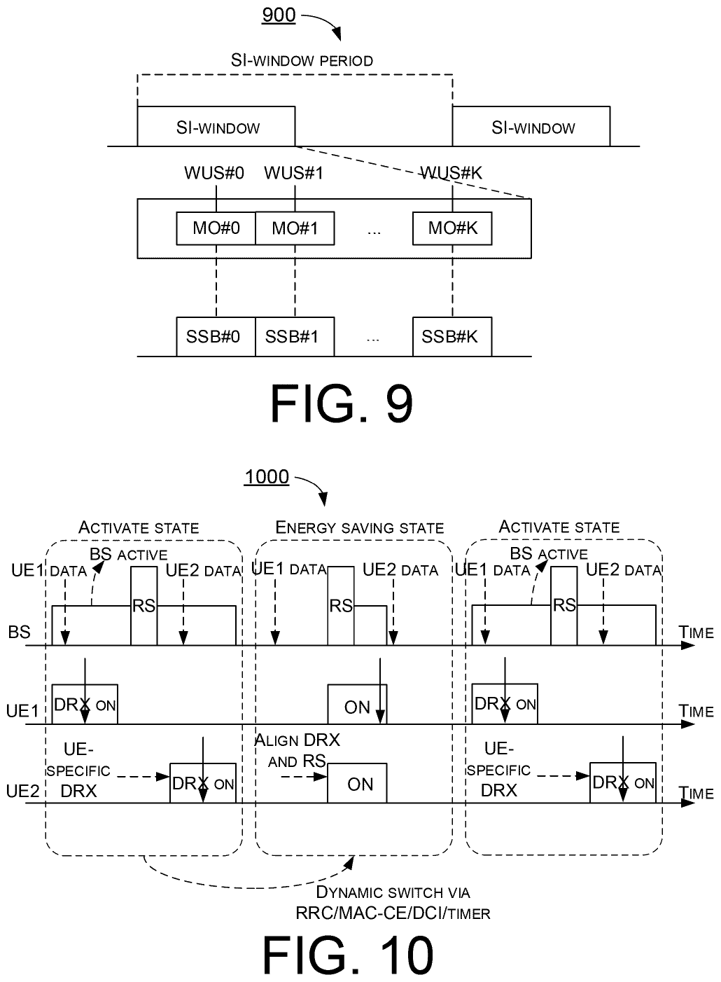

FIG. 9 illustrates an example scenario 900 of SI window for WUS under schemes in accordance with implementations of the present disclosure. Scenario 900 involves a network node (e.g., a macro base station and multiple micro base stations) and a UE, which may be a part of a wireless communication network (e.g., an LTE network, a 5G/NR network, an IoT network or a 6G network). The UE may monitor WUS within the SI window. The UE may monitor one WUS MO out of K WUS MO according to the associated SSB index. In an example, the UE may monitor the WUS MO offset before the start of the SI window, and the UE may receive the offset via RRC or SI from the network node. In another example, the UE may monitor the WUS MO offset after the end of the SI window and the UE may receive the offset via RRC or SI from the network node.

Unlike UE power saving with more sleeping opportunities, the network node usually has less chance to sleep. In addition, the sleeping time of network node may be shorter. In this issue, a faster switch between active and sleep configurations may be helpful. Therefore, the present disclosure proposes some solutions to resolve the issue.

FIG. 10 illustrates an example scenario 1000 of energy saving mode (ESM) switch under schemes in accordance with implementations of the present disclosure. Scenario 1000 involves a network node (e.g., a macro base station and multiple micro base stations) and a UE, which may be a part of a wireless communication network (e.g., an LTE network, a 5G/NR network, an IoT network or a 6G network). The UE may receive an energy saving mode (ESM) indication from the network node via RRC messages, media access control (MAC) control element (MAC-CE) commands, or DCI formats. The ESM indication may be used to trigger new UE behaviors to facilitate BS energy savings. For example, the UE may stop U-DRX and start G-DRX when ESM starts. The UE may restart U-DRX and stop G-DRX when ESM ends. The network node may control the start of ESM or the end of ESM by the ESM indication or a timer ESM-timer. For example, ESM-timer may start or restart when ESM starts. When the ESM-timer expires, ESM may stop. The UE may have different configurations when ESM starts. The configurations may comprises at least one of (1) reference signal (RS) configurations including SSB, channel state information-reference signal (CSI-RS), tracking reference signal (TRS), or demodulation reference signal (DM-RS), (2) carrier aggregation (CA)/dual connectivity (DC) configuration, including no SSB or PDCCH monitoring in secondary cells (SCells), (3) WUS configurations, including monitoring frequency and timing, (4) system information configurations, including broadcast frequency and timing, (5) measurement requirements, including search and measurement time, and (6) random access channel (RACH) configurations, including the timing or the events to initial RACH. In addition, the UE may report whether to support ESM via UE capability information elements of an RRC message. In addition, in EMS state, the DRX and RS may be aligned.

For spatial domain dynamic operation, the number of SSB/CSI-RS beams transmitted simultaneously in a network relates to the number of active transceiver units (TxRU). If SSB/CSI-RS beams and SSB/CSI-RS resources have a one-to-one mapping, then the number of SSB/CSI-RS resources transmitted relates to the number of TxRU. When there is no traffic, some of the SSBs/CSI-RS resources may be muted by network node, in which case there may be impacts on various operations regarding RRC idle and RRC connected state. Therefore, the present disclosure proposes some solutions for UE to handle spatial domain dynamic operation.

The UE may receive an ESM indication when a network node turns off some transceiver units (TxRU) for network power savings. The ESM indication may be indicated via RRC, MAC-CE, or DCI. The ESM indication may be configured per cell, per cell group, or per UE. The UE may receive a list of SSB or CSI-RS resources which are muted or turned off by the network node due to the network node using fewer TxRU for network power saving at the BS side. The UE may receive the list via RRC, MAC-CE, or DCI. The list may include one or multiple groups of SSB or CSI-RS. The UE may determine an update of configurations associated with SSB or CSI-RS when UE receives the ESM indication.

In addition, in some implementations, the UE may receive an indication of a reference signal received power (RSRP) loss or a change of downlink (DL) Energy per Resource Element (EPRE) assumption due to turning off TxRU. The UE may receive the indication via RRC, MAC-CE, or DCI. Values of the indication are set in dBm. The UE may determine an update of configurations associated with RSRP when UE receives the ESM indication.

In addition, in some implementations, the UE may receive an indication for a quasi-co-location (QCL) change due to turning off TxRU. The UE may receive the indication via RRC, MAC-CE, or DCI. The UE may determine an update of configurations associated with QCL when UE receives the ESM indication.

In some implementations, for the random access (RA) procedure, the UE may receive the SSB burst configuration is via SIB and RRC from the network node. When the network node initiates the dynamic spatial operation, the network node may send a group common DCI format to declare a change of the association between RACH occasion (RO) and SSB/CSI-RS resources. The group common DCI format may include RACH configurations for network power savings or provide similar functionalities of RRC IEs, e.g., ssb-perRACH-Occasion, candidateBeamRSList, ra-ssb-OccasionMaskIndex, ssb-perRACH-OccasionAndCB-PreamblesPerSSB, rsrp-ThresholdSSB, msgA-TotalNumberOfRA-Preambles-r16, etc. The UE may ignore an RO if the associated SSB has been turned off.

In some implementations, for the paging occasion (PO), the [x×S+K]-th PDCCH monitoring occasion for paging in the PO corresponds to the K-th transmitted SSB. The PDCCH monitoring occasions for paging are sequentially numbered from zero starting from the first PDCCH monitoring occasion for paging in the paging frame (PF). The network node may control the starting PDCCH monitoring occasion number. When the network node initiates the dynamic spatial operation, the network node may send a group common DCI format to declare a change of the association between PO and SSB. The group common DCI format may include paging configurations for network power savings, e.g., firstPDCCH-MonitoringOccasionOfPO, firstPDCCH-MonitoringOccasionOfPO, nrofPDCCH-MonitoringOccasionPerSSB-InPO, stopPagingMonitoring, etc. The UE may ignore a PO if the associated SSB has been turned off.

In some implementations, for CSI, an SSB and CSI-RS may relate to CSI measurement and CSI reporting. When the network node initiates the dynamic spatial operation, the network node may send a group common DCI format to declare a change of the association between CSI reporting configurations and SSB/CSI-RS resources. The group common DCI format may include measurement configurations, e.g., nrofSS-BlocksToAverage, nrofCSI-RS-ResourcesToAverage, ssb-ToMeasure, CSI-resourceMapping, SRS-ResourceSet, etc. The UE may ignore a CSI report if the associated SSB or CSI-RS has been turned off. The UE may ignore the turned off SSB or CSI-RS for CSI average. The UE may discard the previous CSI measurement before the group common DCI format for the CSI average.

In some implementations, for uplink (UL) power control, the downlink pathloss estimate for physical uplink shared channel (PUSCH), PUCCH, and sounding reference signal (SRS) transmission is provided by pathloss reference signals (PL-RS) associated with a transmission configuration indication (TCI) state including SSB or CSI-RS. When the network node initiates the dynamic spatial operation, the network node may send a group common DCI format to declare a change of the association between PL-RS and SSB/CSI-RS resources. The group common DCI format may include TCI state configurations or similar functionalities, e.g., DLorJoint-TCIState or UL-TCIstate. The UE may ignore the muted SSB or CSI-RS for PL-RS or for UL power control. The UE may apply a default PL-RS instead. Uplink power control may determine the power for PUSCH, PUCCH, SRS, and PRACH transmissions. The UE may receive the number of path loss reference signals (PL-RS), e.g., SSB, or CSI-RS, resources for path-loss estimation for PUSCH/PUCCH/SRS transmissions. The UE may use different PL-RS resources depending upon the type of PUSCH transmission, e.g., SSB for MSG3 PUSCH and SSB or CSI-RS for configured grant and dynamic grant PUSCH. It may be applied to PUCCH as well. In addition, when a network node enters ESM, the network node may indicate the UL power adjustment via a DCI/MAC-CE/RRC. The indication for UL power adjustment may be configured per cell, per cell group, or per UE. Values of the indication may include accumulated or absolute adjustment in decibel (dB).

In some implementations, for semi-persistent scheduling (SPS) PDSCH, the UE may stop SPS PDSCH or PDSCH reception when SPS PDSCH or PDSCH are Quasi Co-located (QCLed) with the muted SSB or CSI-RS. The UE may receive SPS PDSCH or PDSCH if the default QCL for the PDSCH exists.

In some implementations, for QCL, the UE may receive QCL Type D for spatial receiver parameters in a TCI state. The UE may receive 128 TCI states via RRC, 8 TCI activated via MAC-CE, and 1 TCI selected via DCI for PDSCH. For NES, the UE may receive additional TCI states corresponding to the number of active TxRU numbers. For example, a TCI state may include QCL with a CSI-RS or SSB transmitted via 32 TxRU, 16 TxRU, 8 TxRU, and 4 TxRU.

In some implementations, for PUSCH/SRS, the UE may be configured with a list of up to 128 DLorJointTCIState configurations, within the higher layer parameter PDSCH-Config for providing a reference signal for the quasi-co-location for DM-RS of PDSCH and DM-RS of PDCCH in a CC and for CSI-RS. In addition, the configurations may provide a reference, if applicable, for determining UL TX spatial filter for dynamic-grant and configured-grant based PUSCH and PUCCH resource in a CC and SRS. When the network node initiates the dynamic spatial operation, the network node may send a group common DCI format to declare a change of the association between PUSCH/SRS and SSB/CSI-RS resources. The group common DCI format may include TCI state configurations or similar functionalities, e.g., DLorJoint-TCIState or UL-TCIstate. The UE may ignore the muted SSB or CSI-RS for PUSCH/SRS. The UE may apply a default QCL or ignore PUSCH/SRS transmission.

In some implementations, for PDSCH EPRE, if a network node enters ESM, the UE may receive a set of TCI states or a set of RS resource indexes corresponding to a SS/PBCH block or to a CSI-RS resource index for a slot where a PDSCH EPRE adjustment is indicated by DL BS Power Adjustment MAC-CE or DCI. The PDSCH EPRE may be derived from a downlink CSI-RS EPRE and a PDSCH power offset provided by RRC, MAC-CE, or DCI. For a downlink DM-RS and/or phase tracking reference signal (PT-RS) associated with a PDSCH, the UE may assume that the ratio of PDSCH EPRE to DM-RS EPRE, and/or PT-RS EPRE to PDSCH EPRE. If no TCI state or RS resource index is provided to the UE, the UE may assume that a same PDSCH EPRE adjustment applies to all TCI states or RS resource indexes. The downlink SS/PBCH SSS EPRE may be derived from the SS/PBCH downlink transmit power given by the parameter ss-PBCH-BlockPower provided by higher layers. The downlink SSS transmit power may be defined as the linear average over the power contributions (e.g., in Watt) of all resource elements that carry the SSS within the operating system bandwidth. The downlink CSI-RS EPRE may be derived from the SS/PBCH block downlink transmit power given by the parameter ss-PBCH-BlockPower and CSI-RS power offset given by the parameter powerControlOffsetSS provided by higher layers. The CSI-RS may be QCLed with the SS/PBCH block, and the SS/PBCH block can be associated with serving cell physical cell ID (PCI) or additional PCI different from serving cell PCI. The downlink reference-signal transmit power is defined as the linear average over the power contributions (e.g., in Watt) of the resource elements that carry the configured CSI-RS within the operating system bandwidth. The UE may receive an indication via DCI/MAC-CE/RRC to dynamically update ss-PBCH-BlockPower and powerControlOffsetSS if a gNB enters ESM. In addition, the UE may update UL power to send PUSCH, PUCCH, and SRS, e.g., hybrid automatic repeat request (HARQ)-ACK, if the UE receives the indication. The secondary synchronization signal (SSS) is the main reference for transmitting powers in DL. A network node may use RRC IE ss-PBCH-BlockPower to provide the UE with an absolute value for the transmit power of the SSS. When the network node enters ESM, the network node may use DCI/MAC-CE to update the absolute value for the SSS transmission power.

In some implementations, for the BS TX Power Adjustment MAC-CE, the BS TX Power Adjustment MAC-CE is identified by MAC subheader with extended logical channel ID (eLCID). The BS TX Power Adjustment MAC-CE may have a variable size with the following fields. Beam Configuration ID field may indicate the Beam Configuration ID associated with SSB or CSI-RS. Downlink Beam ID field may indicate an indication of the DL beam for which the downlink transmitting power adjustment of the network node is indicated in the DL TX Power Adjustment. BS TX Power adjustment field may indicate the BS TX Power Adjustment indicated by network node to UE. R field may indicate Reserved bit which may be set to 0.

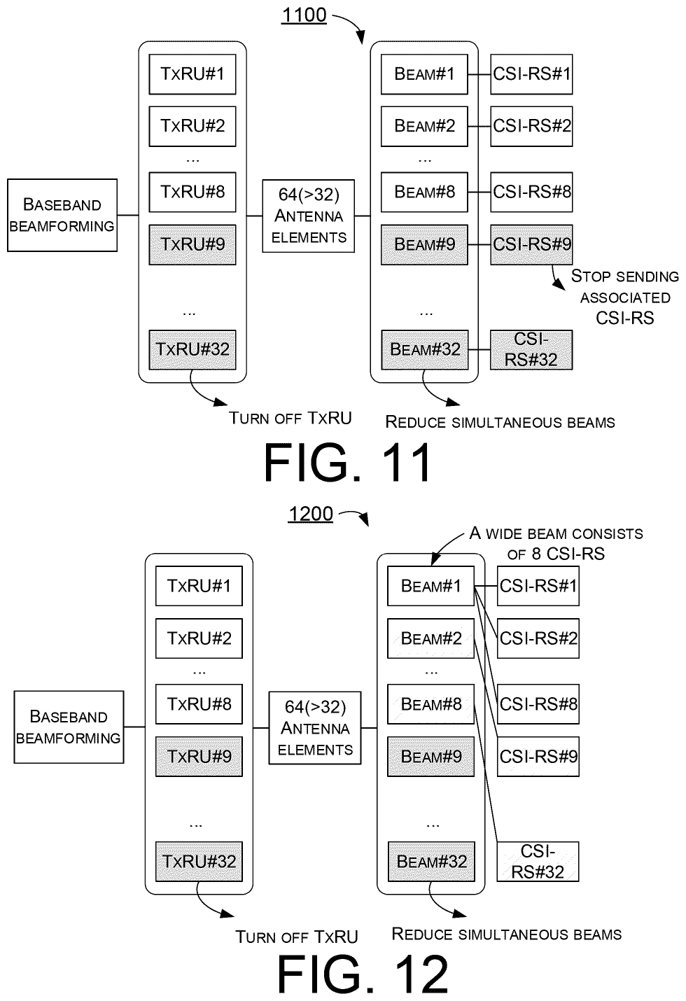

FIG. 11 illustrates an example scenario 1100 of beam configuration for network power saving under schemes in accordance with implementations of the present disclosure. Scenario 1100 involves a network node (e.g., a macro base station and multiple micro base stations) and a UE, which may be a part of a wireless communication network (e.g., an LTE network, a 5G/NR network, an IoT network or a 6G network). As shown in FIG. 11, each beam may correspond to one CSI-RS (e.g., Beam #1 corresponds to CSI-RS #1). When some TxRUs (e.g., TxRU #9-TxRU #32) are turned off by the network node for power saving, the simultaneous beams may be reduced. In addition, the network node may stop sending the CSI-RS associated with the reduced beam.

FIG. 12 illustrates another example scenario 1200 of beam configuration for network power saving under schemes in accordance with implementations of the present disclosure. Scenario 1200 involves a network node (e.g., a macro base station and multiple micro base stations) and a UE, which may be a part of a wireless communication network (e.g., an LTE network, a 5G/NR network, an IoT network or a 6G network). As shown in FIG. 12, each beam may correspond to 8 CSI-RSs (e.g., Beam #1 corresponds to CSI-RS #1-CSI-RS #8). When some TxRUs (e.g., TxRU #9-TxRU #32) are turned off by the network node for power saving, the simultaneous beams may be reduced. In addition, the network node may stop sending the CSI-RS associated with the reduced beam.

For CSI pattern training, the UE may receive multiple SSB or CSI-RS resources beamformed via different numbers of TxRU. The UE may measure these SSB or CSI-RS by different spatial receiver parameters. The UE may store the spatial receiver parameters and uses them to receive a PDSCH when a network node configures the PDSCH is QCLed with the SSB or the CSI-RS.

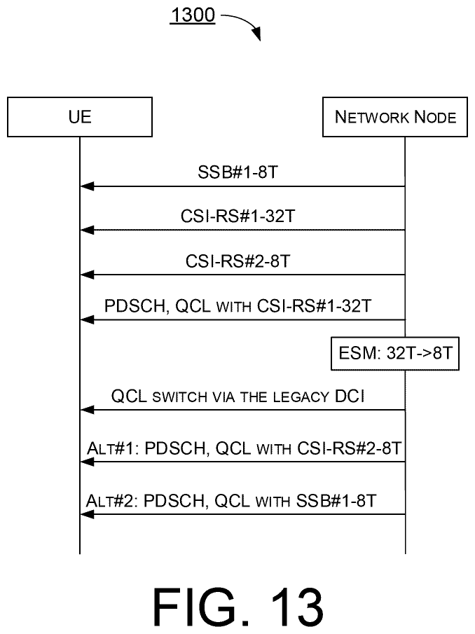

FIG. 13 illustrates an example scenario 1300 of CSI pattern training procedure under schemes in accordance with implementations of the present disclosure. Scenario 1300 involves a network node (e.g., a macro base station and multiple micro base stations) and a UE, which may be a part of a wireless communication network (e.g., an LTE network, a 5G/NR network, an IoT network or a 6G network). The UE may receive SSB #1-8T which indicates 8 (or 32) TxRUs are used to transmit SSB ID #1 from the network. The UE may receive CSI-RS #1-32T which indicates 32 TxRUs are used to transmit CSI-RS ID #1 from the network node. The UE may receive CSI-RS #2-8T which indicates 8 TxRUs are used to transmit CSI-RS ID #2 from the network node. The UE may receive QCL which indicates QCL Type D spatial receiver parameters from the network node. In addition, the UE may receive 128 TCI states via RRC, 8 TCI activated via MAC-CE, and 1 TCI indicated via DCI indicates for PDSCH from the network node. Note the procedure may also be applied to PDCCH. When the network node enters the ESM (e.g., switch from 32 TxRUs to 8 TxRUs), the UE may receive ESM indication with different configurations from the network node. In an example, the UE may receive QCL with CSI-RS #2-8T from network node. In another example, the UE may receive QCL with SSB #1-8T from network node.

In addition, the UE may receive TCI state groups by RRC, where each group has 128 TCI states corresponding to TxRU settings. For example, TCI state group 1 may include CSI-RS or SSB transmitted via 32 TxRU, and TCI state group 2 may contain CSI-RS or SSB transmitted via 8 TxRU. The UE may receive a DCI, MAC-CE, or RRC to switch the TCI state groups for PDSCH or PDCCH reception.

### Illustrative Implementations

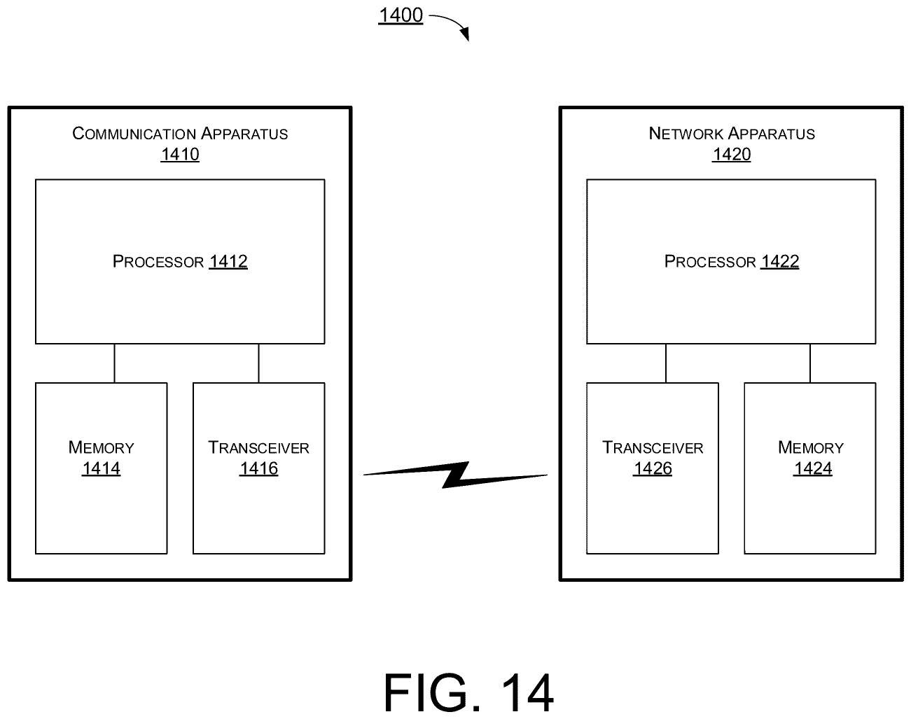

FIG. 14 illustrates an example communication system 1400 having an example communication apparatus 1410 and an example network apparatus 1420 in accordance with an implementation of the present disclosure. Each of communication apparatus 1410 and network apparatus 1420 may perform various functions to implement schemes, techniques, processes and methods described herein pertaining to network power saving with respect to user equipment and network apparatus in mobile communications, including scenarios/schemes described above as well as process 1500 described below.

Communication apparatus 1410 may be a part of an electronic apparatus, which may be a UE such as a portable or mobile apparatus, a wearable apparatus, a wireless communication apparatus or a computing apparatus. For instance, communication apparatus 1410 may be implemented in a smartphone, a smartwatch, a personal digital assistant, a digital camera, or a computing equipment such as a tablet computer, a laptop computer or a notebook computer. Communication apparatus 1410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1410 may be implemented in a smart thermostat, a smart fridge, a smart door lock, a wireless speaker or a home control center. Alternatively, communication apparatus 1410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1410 may include at least some of those components shown in FIG. 14 such as a processor 1412, for example. Communication apparatus 1410 may further include one or more other components not pertinent to the proposed scheme of the present disclosure (e.g., internal power supply, display device and/or user interface device), and, thus, such component(s) of communication apparatus 1410 are neither shown in FIG. 14 nor described below in the interest of simplicity and brevity.

Network apparatus 1420 may be a part of a network apparatus, which may be a network node such as a satellite, a base station, a small cell, a router or a gateway. For instance, network apparatus 1420 may be implemented in an eNodeB in an LTE network, in a gNB in a 5G/NR, IoT, NB-IoT or IIoT network or in a satellite or base station in a 6G network. Alternatively, network apparatus 1420 may be implemented in the form of one or more IC chips such as, for example and without limitation, one or more single-core processors, one or more multi-core processors, or one or more RISC or CISC processors. Network apparatus 1420 may include at least some of those components shown in FIG. 14 such as a processor 1422, for example. Network apparatus 1420 may further include one or more other components not pertinent to the proposed scheme of the present disclosure (e.g., internal power supply, display device and/or user interface device), and, thus, such component(s) of network apparatus 1420 are neither shown in FIG. 14 nor described below in the interest of simplicity and brevity.

In one aspect, each of processor 1412 and processor 1422 may be implemented in the form of one or more single-core processors, one or more multi-core processors, or one or more CISC processors. That is, even though a singular term “a processor” is used herein to refer to processor 1412 and processor 1422, each of processor 1412 and processor 1422 may include multiple processors in some implementations and a single processor in other implementations in accordance with the present disclosure. In another aspect, each of processor 1412 and processor 1422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1412 and processor 1422 is a special-purpose machine specifically designed, arranged and configured to perform specific tasks including autonomous reliability enhancements in a device (e.g., as represented by communication apparatus 1410) and a network (e.g., as represented by network apparatus 1420) in accordance with various implementations of the present disclosure.

In some implementations, communication apparatus 1410 may also include a transceiver 1416 coupled to processor 1412 and capable of wirelessly transmitting and receiving data. In some implementations, communication apparatus 1410 may further include a memory 1414 coupled to processor 1412 and capable of being accessed by processor 1412 and storing data therein. In some implementations, network apparatus 1420 may also include a transceiver 1426 coupled to processor 1422 and capable of wirelessly transmitting and receiving data. In some implementations, network apparatus 1420 may further include a memory 1424 coupled to processor 1422 and capable of being accessed by processor 1422 and storing data therein. Accordingly, communication apparatus 1410 and network apparatus 1420 may wirelessly communicate with each other via transceiver 1416 and transceiver 1426, respectively. To aid better understanding, the following description of the operations, functionalities and capabilities of each of communication apparatus 1410 and network apparatus 1420 is provided in the context of a mobile communication environment in which communication apparatus 1410 is implemented in or as a communication apparatus or a UE and network apparatus 1420 is implemented in or as a network node of a communication network.

In some implementations, processor 1412 may receive, via transceiver 1416, a power saving indication from network apparatus 1420. Processor 1412 may obtain power saving information according to the power saving indication. The power saving indication may comprise at least one of a DRX switch indicator for switching between a U-DRX and a G-DRX, an EMS indication, a list of SSB or CSI-RS resources, and a set of TCI states or RS resource indexes.

In some implementations, processor 1412 may receive, via transceiver 1416, at least one G-DRX parameter from network apparatus 1420. Processor 1412 may receive, via transceiver 1416, the DRX switch indicator. Processor 1412 may switch the U-DRX to or from the G-DRX according to the DRX switch indicator and the at least one G-DRX parameter. Processor 1412 may perform a PDCCH monitoring within an on-duration configured by the U-DRX or the G-DRX according the DRX switch indicator.

In some implementations, processor 1412 may receive, via transceiver 1416, the at least one G-DRX parameter through a RRC signaling or SI configured per cell or cell group.

In some implementations, processor 1412 may switch between the U-DRX and the G-DRX based on a G-DRX timer after receiving the DRX switch indicator. Processor 1412 may perform the PDCCH monitoring within the on-duration configured by the G-DRX when the G-DRX timer is running.

In some implementations, processor 1412 may receive, via transceiver 1416, the EMS indication from network apparatus 1420 in an event that network apparatus 1420 enters a power saving mode. Processor may determine updated configurations associated with SSB or CSI-RS resources according to the EMS indication. Processor may perform a CSI measurement or a CSI reporting via the SSB or CSI-RS resources according to the updated configurations.

In some implementations, EMS indication may be configured per cell, cell group or UE.

In some implementations, processor 1412 may receive, via transceiver 1416, the list of SSB or CSI-RS resources which are muted or turned off from network apparatus 1420 in an event that network apparatus 1420 enters a power saving mode.

In some implementations, the list may comprise one or multiple groups of SSBs or CSI-RSs.

In some implementations, processor 1412 may receive, via transceiver 1416 the set of TCI states or RS resource indexes corresponding to at least one CST-RS resource index for a slot where a PDSCH EPRE adjustment is indicated in an event that network apparatus 1420 enters a power saving mode. Processor 1412 may perform a CSI measurement or a CSI reporting via SSB or CSI-RS resources according to the indicated PDSCH EPRE adjustment.

In some implementations, processor 1412 may receive, via transceiver 1416 the power saving indication from network apparatus 1420 through a RRC signaling, a MAC-CE, or a DCI.

### Illustrative Processes

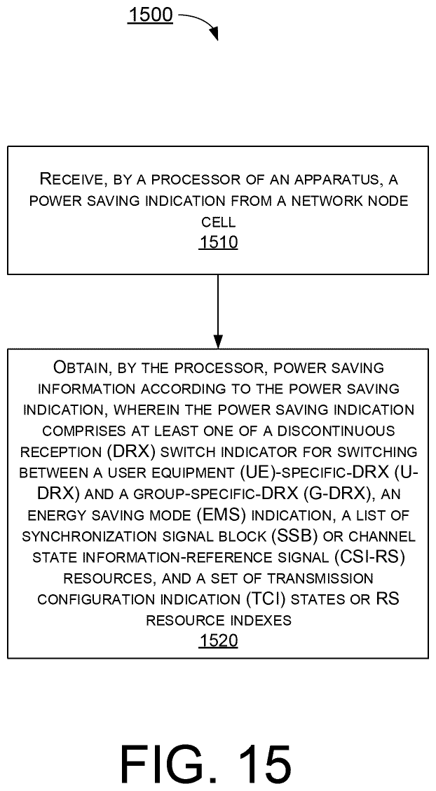

FIG. 15 illustrates an example process 1500 in accordance with an implementation of the present disclosure. Process 1500 may be an example implementation of above scenarios/schemes, whether partially or completely, with respect to network power saving with the present disclosure. Process 1500 may represent an aspect of implementation of features of communication apparatus 1410. Process 1500 may include one or more operations, actions, or functions as illustrated by one or more of blocks 1510 and 1520. Although illustrated as discrete blocks, various blocks of process 1500 may be divided into additional blocks, combined into fewer blocks, or eliminated, depending on the desired implementation. Moreover, the blocks of process 1500 may be executed in the order shown in FIG. 15 or, alternatively, in a different order. Process 1500 may be implemented by communication apparatus 1410 or any suitable UE or machine type devices. Solely for illustrative purposes and without limitation, process 1500 is described below in the context of communication apparatus 1410. Process 1500 may begin at block 1510.

At 1510, process 1500 may involve processor 1412 of communication apparatus 1410 receiving a power saving indication from a network node. Process 1500 may proceed from 1510 to 1520.

At 1520, process 1500 may involve processor 1412 obtaining power saving information according to the power saving indication. The power saving indication may comprise at least one of a DRX switch indicator for switching between a UE-specific-DRX (U-DRX) and a group-specific-DRX (G-DRX), an EMS indication, a list of SSB or CSI-RS resources, and a set of TCI states or RS resource indexes.

In some implementations, process 1500 may involve processor 1412 receiving at least one G-DRX parameter from the network node. Process 1500 may involve processor 1412 receiving the DRX switch indicator. Process 1500 may involve processor 1412 switching the U-DRX to or from the G-DRX according to the DRX switch indicator and the at least one G-DRX parameter. Process 1500 may involve processor 1412 performing a PDCCH monitoring within an on-duration configured by the U-DRX or the G-DRX according the DRX switch indicator.

In some implementations, process 1500 may involve processor 1412 receiving the at least one G-DRX parameter through an RRC signaling or system information (SI) configured per cell or cell group.

In some implementations, process 1500 may involve processor 1412 switching between the U-DRX and the G-DRX based on a G-DRX timer after receiving the DRX switch indicator. Process 1500 may involve processor 1412 performing the PDCCH monitoring within the on-duration configured by the G-DRX when the G-DRX timer is running.

In some implementations, process 1500 may involve processor 1412 receiving the EMS indication from the network node in an event that the network node enters a power saving mode. Process 1500 may involve processor 1412 determining updated configurations associated with SSB or CSI-RS resources according to the EMS indication. Process 1500 may involve processor 1412 performing a CSI measurement or a CSI reporting via the SSB or CSI-RS resources according to the updated configurations.

In some implementations, process 1500 may involve processor 1412 receiving the list of SSB or CSI-RS resources which are muted or turned off from the network node in an event that the network node enters a power saving mode.

In some implementations, process 1500 may involve processor 1412 receiving the set of TCI states or RS resource indexes corresponding to at least one CSI-RS resource index for a slot where a PDSCH EPRE adjustment is indicated in an event that the network node enters a power saving mode. Process 1500 may involve processor 1412 performing a CSI measurement or a CSI reporting via SSB or CSI-RS resources according to the indicated PDSCH EPRE adjustment.

In some implementations, process 1500 may involve processor 1412 receiving the power saving indication from the network node through an RRC signaling, a MAC-CE, or a DCI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a power saving indication from a network node; and
obtaining, by the processor, power saving information according to the power saving indication,
wherein the power saving indication comprises at least one of a discontinuous reception (DRX) switch indicator for switching between a user equipment (UE)-specific-DRX (U-DRX) and a group-specific-DRX (G-DRX), an energy saving mode (EMS) indication, a list of synchronization signal block (SSB) or channel state information-reference signal (CSI-RS) resources, and a set of transmission configuration indication (TCI) states or RS resource indexes.

2. The method of claim 1, further comprising:
receiving, by the processor, at least one G-DRX parameter from the network node;
receiving, by the processor, the DRX switch indicator;
switching, by the processor, the U-DRX to or from the G-DRX according to the DRX switch indicator and the at least one G-DRX parameter; and
performing, by the processor, a physical downlink control channel (PDCCH) monitoring within an on-duration configured by the U-DRX or the G-DRX according the DRX switch indicator.

3. The method of claim 2, wherein the receiving of the at least one G-DRX parameter comprises:
receiving, by the processor, the at least one G-DRX parameter through a radio resource control (RRC) signaling or system information (SI) configured per cell or cell group.

4. The method of claim 2, wherein the switching of the U-DRX to or from the G-DRX according to the DRX switch indicator and the at least one G-DRX parameter further comprises:
switching, by the processor, between the U-DRX and the G-DRX based on a G-DRX timer after receiving the DRX switch indicator; and
performing, by the processor, the PDCCH monitoring within the on-duration configured by the G-DRX when the G-DRX timer is running.

5. The method of claim 1, further comprising:
receiving, by the processor, the EMS indication from the network node in an event that the network node enters a power saving mode;
determining, by the processor, updated configurations associated with SSB or CSI-RS resources according to the EMS indication; and
performing, by the processor, a CSI measurement or a CSI reporting via the SSB or CSI-RS resources according to the updated configurations.

6. The method of claim 5, wherein EMS indication is configured per cell, cell group or UE.

7. The method of claim 1, further comprising:
receiving, by the processor, the list of SSB or CSI-RS resources which are muted or turned off from the network node in an event that the network node enters a power saving mode.

8. The method of claim 7, wherein the list comprises one or multiple groups of SSBs or CSI-RSs.

9. The method of claim 1, further comprising:
receiving, by the processor, the set of TCI states or RS resource indexes corresponding to at least one CSI-RS resource index for a slot where a physical downlink shared channel (PDSCH) energy per resource element (EPRE) adjustment is indicated in an event that the network node enters a power saving mode; and
performing, by the processor, a CSI measurement or a CSI reporting via SSB or CSI-RS resources according to the indicated PDSCH EPRE adjustment.

10. The method of claim 1, wherein the receiving of the power saving indication comprises:
receiving, by the processor, the power saving indication from the network node through a radio resource control (RRC) signaling, a media access control (MAC) control element (MAC-CE), or a downlink control information (DCI).

11. An apparatus, comprising:
a transceiver which, during operation, wirelessly communicates with at least one network node; and
a processor communicatively coupled to the transceiver such that, during operation, the processor performs operations comprising:
receiving, via the transceiver, a power saving indication from the network node; and
obtaining power saving information according to the power saving indication,
wherein the power saving indication comprises at least one of a discontinuous reception (DRX) switch indicator for switching between a user equipment (UE)-specific-DRX (U-DRX) and a group-specific-DRX (G-DRX), an energy saving mode (EMS) indication, a list of synchronization signal block (SSB) or channel state information-reference signal (CSI-RS) resources, a set of transmission configuration indication (TCI) states or RS resource indexes.

12. The apparatus of claim 11, wherein, during operation, the processor further performs operations comprising:
receiving, via the transceiver, at least one G-DRX parameter from the network node;
receiving, via the transceiver, the DRX switch indicator;
switching the U-DRX to or from the G-DRX according to the DRX switch indicator and the at least one G-DRX parameter; and
performing a physical downlink control channel (PDCCH) monitoring within an on-duration configured by the U-DRX or the G-DRX according the DRX switch indicator.

13. The apparatus of claim 12, wherein, in receiving the at least one G-DRX parameter, the processor receives the at least one G-DRX parameter through a radio resource control (RRC) signaling or system information (SI) configured per cell or cell group.

14. The apparatus of claim 12, wherein, in switching the U-DRX to or from the G-DRX according to the DRX switch indicator and the at least one G-DRX parameter, the processor switches between the U-DRX and the G-DRX based on a G-DRX timer after receiving the DRX switch indicator, and performs the PDCCH monitoring within the on-duration configured by the G-DRX when the G-DRX timer is running.

15. The apparatus of claim 11, wherein, during operation, the processor further performs operations comprising:
receiving, via the transceiver, the EMS indication from the network node in an event that the network node enters a power saving mode;
determining updated configurations associated with SSB or CSI-RS resources according to the EMS indication; and
performing a CSI measurement or a CSI reporting via the SSB or CSI-RS resources according to the updated configurations.

16. The apparatus of claim 15, wherein EMS indication is configured per cell, cell group or UE.

17. The apparatus of claim 11, wherein, during operation, the processor further performs operations comprising:
receiving, via the transceiver, the list of SSB or CSI-RS resources which are muted or turned off from the network node in an event that the network node enters a power saving mode.

18. The apparatus of claim 17, wherein the list comprises one or multiple groups of SSBs or CSI-RSs.

19. The apparatus of claim 11, wherein, during operation, the processor further performs operations comprising:
receiving, via the transceiver, the set of TCI states or RS resource indexes corresponding to at least one CSI-RS resource index for a slot where a physical downlink shared channel (PDSCH) energy per resource element (EPRE) adjustment is indicated in an event that the network node enters a power saving mode; and
performing a CSI measurement or a CSI reporting via SSB or CSI-RS resources according to the indicated PDSCH EPRE adjustment.

20. The apparatus of claim 11, wherein, in receiving the power saving indication, the processor receives the power saving indication from the network node through a radio resource control (RRC) signaling, a media access control (MAC) control element (MAC-CE), or a downlink control information (DCI).
